(19) United States
(12) Patent Application Publication
(10) Pub. No.: US 2012/0277991 A1
(43) Pub. Date: Nov. 1, 2012

(54) SHOPPING SYSTEM AND METHOD

(75) Inventors: Nathanial Wagner, Carmel, IN (US); Dwayne Hurt, Carmel, IN (US)

(73) Assignee: BACOMPT SYSTEMS, INC., Carmel, IN (US)

(21) Appl. No.: 13/382,226

(22) PCT Filed: Jun. 28, 2010
(86) PCT No.: PCT/US10/40170

§ 371 Date: Jul. 19, 2012

Related U.S. Application Data
(60) Provisional application No. 61/221,041, filed on Jun. 27, 2009.

(51) Int. Cl. G06Q 30/00; G01C 21/00

(52) U.S. Cl. 701/410; 705/26.8

(57) ABSTRACT

The present invention provides a shopping method and system that allows a consumer who is unfamiliar with a particular store to generate a shopping list integrated into a map and quickly locate the items within the store. The typical problems associated with finding items in a store with an unfamiliar layout can thereby be avoided. In one embodiment, the present invention provides a map that can be either in electronic or paper form. Indicia of each item on the consumer's shopping list are placed on the map in the location each item can be found in the store.

### RELATED APPLICATIONS

This application claims priority to U.S. application Ser. No. 61/221,041, filed Jun. 27, 2009, the entire disclosure of which is hereby incorporated herein by reference.

### BACKGROUND

Shopping at grocery stores typically involves creating a list of items desired to be purchased before travelling to the store. Once at the store, the consumer locates within the store each item on the list and typically places it in a shopping cart. While most stores have a structured organization governing where items are located, it varies from store to store. In a store that is new to a consumer, the experience of finding items can be quite frustrating. For example, a consumer may exhaustively search one or more store aisles where the item sought is believed to be located, only to find that the item is located somewhere else in the store, or, worse yet, not carried by the store at all. If several items cannot be located, which is often the experience of consumers in stores that are new to them, the shopping experience can be overly time-consuming, frustrating and exhausting. Because of this difficulty, shoppers often shop at only the grocery store with which they have become familiar and are hesitant to try a new store.

Thus, there is a resistance for consumers to try a new store because of consumers' expectations of encountering difficulties in finding desired items and not wanting to waste time. Coupons and sales are known and can be used to lure consumers into a new store. However, it has been found that many consumers will forgo any savings achieved by these known marketing techniques in favor of the more expensive but familiar store at which they normally shop.

What is needed is a method and system that addresses these difficulties.

### SUMMARY OF THE INVENTION

The present invention provides a shopping method and system that allows a consumer who is unfamiliar with a particular store to generate a shopping list and quickly locate the items on the list within the store. The typical problems associated with finding items in a new store with an unfamiliar layout can thereby be avoided. In one embodiment, the present invention incorporates a shopping list into a map that can be either in electronic or paper form. Indicia of each item on the consumer's shopping list are placed on the map in the location each item can be found in the store.

In one form thereof, the present invention provides a method of creating and using a customized shopping map. In this method, as an initial step the user enters a store's website. The website then communicates with a main server. The user can then build a shopping list by entering the items wished to be purchased or clicking certain icons. The shopping list is to be used while the user visits the physical location of the store. The server may store information about the particular user which may allow the website to, e.g., provide prompts to the user concerning items frequently purchased by the user during the building of the list. The completed list is compiled and the items are sorted by their physical location in the store. A map is then generated of the store which includes indicia indicating the locations of the items on the list. For example, the map may show a layout of the store by aisle and the items may have numbered icons placed on the map at the locations the items can be found in the physical store. The map is thus used by the consumer while in the store to locate and purchase one or more of the items on the list.

In one exemplary embodiment, the map can be downloaded to a portable electronic device, wherein the map comprises an image viewable on or from the portable electronic device. Optionally, the portable electronic device may include GPS, such that the method also includes navigating the consumer to the exact location in the store of at least one the items on the shopping list of items. The GPS can be integrated with the map, such that the location in real time of the user, and items on the list can be viewed on the map in real time.

In another variant of the disclosed method, the indicia can comprise Arabic numbers located on the map in positions corresponding to the location of the items in the store. The indicia may further include colors, the colors corresponding to a type of item. For example, one color may correspond to “dairy,” whereas another color may correspond to “meats,” and so forth.

One advantage of the invention is that it provides a higher amount of freedom in choosing a store. This is because the consumer is no longer restricted to shopping in a particular store with which he is familiar and thus already knows the locations of the desired items. Instead, with the instant invention, the consumer can shop at a new store and find and purchase items as quick or quicker than in a store having a familiar layout.

In this connection, the instant invention can even be advantageous for use in an existing store. While the consumer may already have a general idea of where the items in the store are located, the instant invention can pinpoint those items and allow the consumer to reach them quicker. Furthermore, items that the consumer has not previously purchased from a known store can also be mapped and located with ease using the present invention.

### BRIEF DESCRIPTION OF THE DRAWINGS

The above-mentioned aspects of the present invention and the manner of obtaining them will become more apparent and the invention itself will be better understood by reference to the following description of the embodiments of the invention taken in conjunction with the accompanying drawings, wherein:

FIG. 1A is a flowchart showing the inventive shopping method and system and various features thereof;

FIG. 1B is a continuation of the flowchart of FIG. 1A;

FIG. 2 is a representation of a map generated by the shopping method in accordance with one embodiment;

FIG. 3 is a flowchart showing the formation and use of a flyer in accordance with an embodiment of the invention;

FIG. 4 is a representation of a flyer used in accordance with an embodiment of the invention; and

FIGS. 5A and 5B are a representation of a list of common items that may be generated and provided in certain embodiments of the present invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

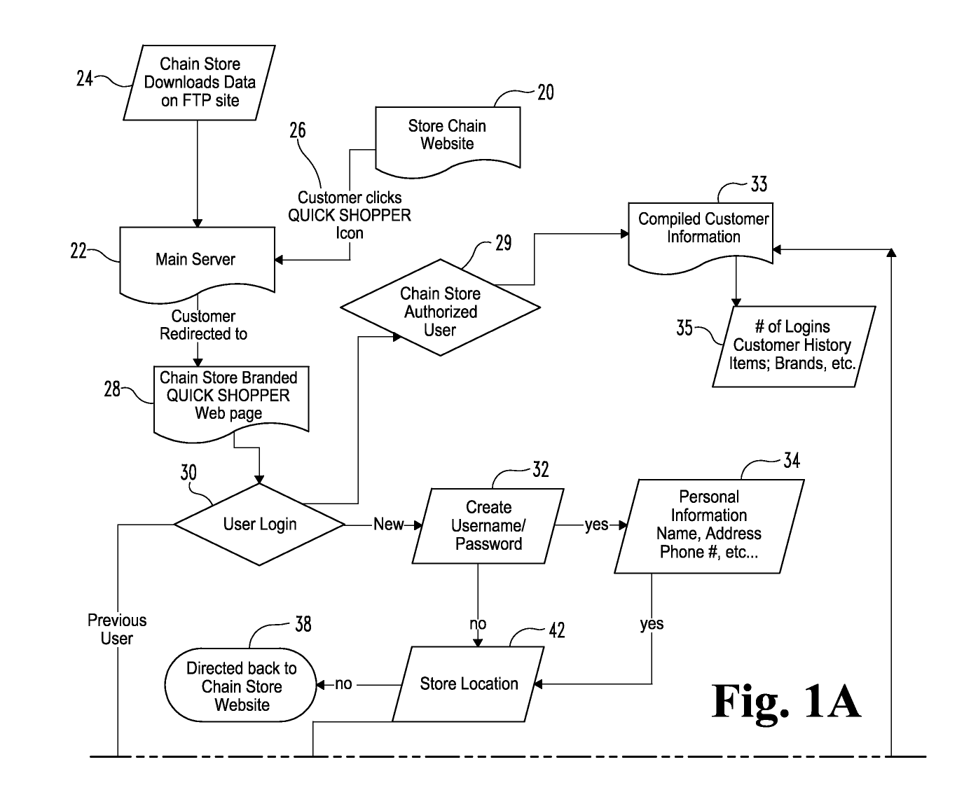

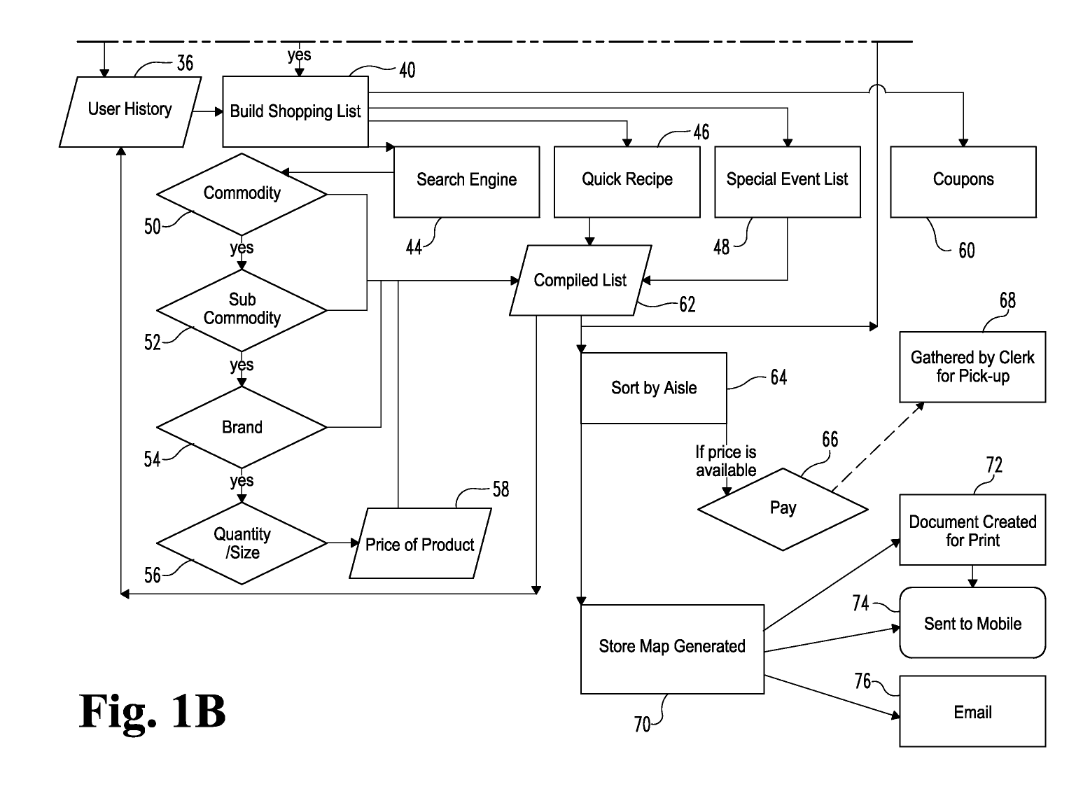

Turning now to FIG. 1A, a store such as, e.g., a grocery store chain may have a website indicated generally at 20. Website 20 can be operated by the store, or by administrative offices for the store. Alternatively, the store website can be operated by a third party to which the store provides the necessary information to maintain the features described below. The store can also have a website that links to the third-party website transparently to the user such that it still appears to the customer that they are on the store website. The third party website can include store branding and other store indicia to make it appear to the customer that they have not left the store website.

The store website system can include a server 22 maintained by the store or the third party. If the server 22 is maintained by a third party it can be coupled over a network to a server maintained by the store to transfer data between the servers and to transfer a customer session between the servers. The server can accept downloads 24 of updated information for the store to keep the information presented to the customer current and accurate.

In one embodiment, a website maintained by the store has an icon, e.g., “quick shopper,” for building a shopping list and store mapping. When the quick shopper icon is clicked from the store's website as indicated at 26, the consumer is redirected to a tailored website 28 designed to mimic the appearance of the store's website 20. The store website can include a user login function 30 to process new and existing store account holders. The login function can include username and password fields 32 to identify existing account holders and associate their website activity with the existing customer account. The login function can also include an account creation procedure 34 through which a new user creates an account. The account creation procedure can include fields for the consumer to provide personal information, for example, name, address, store location preference, phone number, and other personal information. The store can determine the personal information to be collected from the customer. The information gathered from any use of the store website under the customer's account can be stored in a user history file 36. This user history file can then be used by the store to create advertising and marketing targeted to specific customers.

Once logged in and verified as an authorized user, the consumer can then compile their personalized shopping list (see reference numeral 40) using a search engine, recipe function, event function, and/or coupon features, described in more detail below. From this data, a custom-made store shopping list and store map for the list is created. At this point the consumer can decide how they would prefer to use their list and map, for example by personally selecting the items using a printed or electronically displayed list and map; or by having the store accumulate the items on the list for pick-up by them or someone else, or by sending the list to someone else to select from the shelves. When the customer has completed compiling their shopping list, they can then be directed to the store website and the user history can be gathered and stored for both retailer and consumer to use later.

After the consumer successfully logs into the store website they can be brought to a location selection screen or directly to a location welcome screen. The location selection screen can provide the customer with data entry and/or pull-down menu fields or map displays through which the customer can view available store locations and select a particular location 42 for the current shopping trip. Once the user selects a particular store location, the customer is brought to the location welcome screen for that store location.

The location welcome screen can include a build shopping list function 40 and advertised specials for the particular store location. If the customer selects one of the advertised specials, then that item can be automatically added to the customer's shopping list populated by the build shopping list function 40. The build shopping list function 40 can include one or more of a quick search feature (as part of search engine 44), a quick recipe feature 46, or a special event feature 48.

The quick search feature 44 enables the customer to narrow the search of items from commodity 50 to sub-commodity 52 to brand 54 to size 56 to the specific item to be added to the shopping list.

The shopping list function 40 also enables the user to edit or delete items on the shopping list. The user can delete an item from the shopping list by simply selecting the item on the shopping list and selecting a delete key on the screen or keyboard. The user can edit an item on the shopping list by selecting the item on the shopping list and then modifying the item, such as to choose a different brand or size. This can be implemented by allowing the user to go in the reverse direction through the quick search feature, for example, to start with a particular item on the shopping list; then selecting a back button to be presented with size selections from which the user can select a different size for the selected item on the shopping list; or again selecting the back button to be presented with brand selections from which the user can select a different brand for the selected item on the shopping list; or again selecting the back button to be presented with sub-commodity selections from which the user can select a replacement sub-commodity for the selected item on the shopping list; or again selecting the back button to be presented with commodity selections from which the user can select a replacement commodity for the selected item on the shopping list. Once the user chooses a new commodity, sub-commodity, brand, size etc., they then proceed through the quick search feature to identify the specific item to be added to the shopping list in place of the modified item. Of course, there can be more or less levels in the selection choices for modifying or selecting a particular item.

The quick recipe feature 46 can display various recipes and pictures of the finally prepared recipe. For example, the quick recipe feature could include apple pie, or peppered salmon with citrus slaw. Each recipe includes a list of ingredients with suggested brands and sizes for each ingredient. If the user selects a particular recipe, each ingredient used in the recipe is automatically added to the shopping list. The user can then select any item on the shopping list and delete it, for example if they already have that ingredient at home, or modify it if they prefer an alternative brand. Alternatively, the user can select individual items from the recipe to add to the shopping list and then modify if desired. The suggested brand and size in the recipe can be part of promotional agreements that the store or the third party website developer has negotiated.

The special event feature 48 can display upcoming events, for example an Independence Day cook-out. Similar to the quick recipe features, the event has a list of items associated with the event. The customer can choose to have all of the items associated with the event added to the shopping list or individually select items associated with the event and add them to the shopping list. Once on the shopping list 40, the user can delete or modify the items on the shopping list. The suggested brand and size in the upcoming event listing can be part of promotional agreements that the store or the third party website developer has negotiated.

A coupons feature 60 displays coupons available to the customer. These coupons can be for all stores, or a particular chain or a particular store. If selected by the customer, the item on the coupon will be added to the shopping list and the coupon will be added to the output that includes the shopping list. The coupon can be printed as part of the shopping list, or if the shopping list is created using a device that does not have access to a printer, the coupon can be printed at the store during checkout. If the coupon provides the customer with a selection of items, such as any cereal of a particular brand, the customer can be presented with a selection of applicable items from which to select the particular item or items to add to the shopping list.

The completed shopping list has a listing of each item selected by the customer including the desired brand and size. The shopping list also includes any coupons selected by the customer. The shopping list can also include pricing as indicated at 58, so the customer can make price decisions while creating the list and know the individual item prices on the shopping list and the total price of all items selected. The shopping list is compiled (see reference numeral 62) and generally sorted by store isle 64.

The pay feature 66 can enable the customer to transmit the completed shopping list to the store to be made ready for their pick-up as indicated at 68. Alternatively, the customer can go to the store and use the store mapping to find and select the items from the shelves. As described in more detail below, a shopping list in the form of a store mapping 70 is generated. Map 70 can be printed (see 72) to bring to the store or can be displayed on a mobile display device (see 74), for example, a personal digital assistant (PDA) or portable computer. The shopping list and store mapping can already be downloaded on the portable device.

Alternatively, the store can provide wireless network access for the customer to access the store website to create and modify the shopping list, and to use the store mapping to find items in the store. As another option, the customer that built the shopping list can send the shopping list and store mapping to a desired e-mail address as indicated at 76, after which the recipient can go to the store to select the items on the list. The customer could also transmit the list to the store and an e-mail recipient, to have the store have the items already collected for the recipient's pick-up at the store.

During all of the customer's interaction with the store website, a user history 36 is collected for the future use of the customer and the store.

The shopping system can include options to initially populate or accumulate the customer's shopping list. For example, these options can include a repeat last order option, a regular order option, and/or a current order option. The repeat last order option fills the shopping list with the previous shopping list created by the customer. The regular order option fills the shopping list with a recurring list of items created by the customer and stored in the customer's user history. The current order option allows the customer to add items to their shopping list when they remember and have access to the website and save the list. Then over the course of the week they can have a list of everything they thought of during the week on the current order shopping list. After the customer has accumulated or started their shopping list with one of these options, they can then use the add, delete and modify options described above to further customize the shopping list for this shopping trip.

As alluded above, in accordance with a significant advantage of these teachings, the system is programmed to generate a map at step 70, which comprises a graphically designed image of the complete retail floor plan of the store, aisle by aisle, including cash registers, customer service office, meat department, bakery, floral department, etc. The store mapping can depict item locations for each item on the shopping list. The shopping list items can be located and placed on the store mapping by commodity, sub commodity, brand, and/or size. The map can have many forms and formats and can be generated in many mediums, such as a hard copy document 72, mobile devices 74 and email 76, etc.

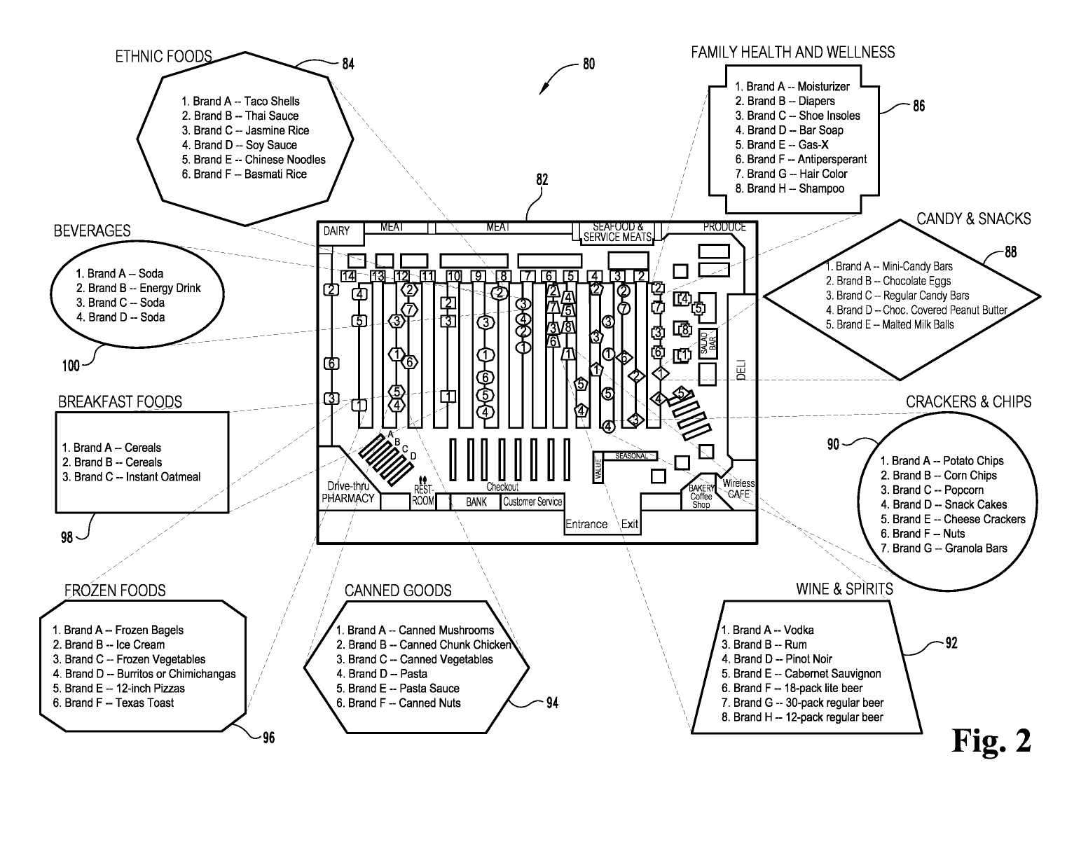

One embodiment of a map-shopping list 80 is shown in FIG. 2. It should be understood that map-shopping list 80 is for a particular store, which in most cases is unique, even if part of a larger store chain. Centered in FIG. 2 is the store layout map 82 which shows various areas of the store. Around the periphery is shown the dairy, meat, seafood sections, and the like. Map 82 also shows aisles (unnumbered for clarity), which are common in most grocery store layouts.

Advantageously, map-list 80 not only shows the layout of the store, it is integrated with the customer's unique shopping list, which has been arranged in this illustrated embodiment to assist the user in quickly locating the items on the list in the store. Several bursts are arranged around the map 82, and include ethnic foods 84, family health and wellness 86, candy and snacks 88, crackers and chips 90, wine and spirits 92, canned goods 94, frozen foods 96, breakfast foods 98 and beverages 100.

Each burst has a shape or indicia uniquely identifying it. For example, the ethnic foods burst 84 is a polygonal shape within which is listed the items on the list that fall into this category; i.e., a sub-list. Each item in the ethnic foods category has been assigned a number and these numbers have smaller polygonal shaped borders surrounding the numbers. Although unique shapes are illustrated in FIG. 2, it should be understood that other schemes and indicia for categorizing the list could be used instead, in particular, color coding of each category and associated numbers on the map. In any event, the consumer can easily identify the numbered items on the ethnic food list on map 82 by the polygonal indicia surrounding the numbered items. As shown on map 82, the six numbered items in the ethnic foods category area are all in the same aisle, with only item number 2 being on the opposite side of the isle as the other ethnic food items. A consumer can thus add the items in the ethnic foods category to his shopping cart all at once. As can be appreciated from FIG. 2, the other categories are arranged likewise. The candy and snacks burst 88 and associated items on the map, for example, have diamond shaped indicia, crackers and chips are round, and so forth. It can thus be appreciated that the map-list embodiment shown in FIG. 2 breaks the shopping list down into sub-lists arranged by category and then uniquely indicates the location of each item in each category on the map 82. In this manner, the consumer can shop by category, which mimics a conventional method of unassisted shopping.

Other map-list embodiments are possible and within the scope of the invention. For example, all items on the consumer's list can be arranged by the system in a list numbered in the order in which the items are to be placed into the consumer's cart. Similar to the embodiment shown in FIG. 2, the items would all be shown by their associated numbers on the map. However, in this embodiment, economy and efficiency takes precedence over category. For example, the consumer may proceed down a given aisle and add bread, beer, pretzels and fish in his or her cart before proceeding to the next aisle. In this embodiment, the consumer will typically travel up or down each aisle only once. It is also possible in this embodiment to provide a line on the map with arrows to show the path the consumer is to take. The path can be enhanced, for example, by showing the customer coupons or specials that the customer will pass during shopping.

In other embodiments, the map can be integrated with a Global Positioning System (GPS). That is, the location coordinates of the store and all items therewithin can be uploaded to the web-based system described above in the same fashion in which particular addresses and streets are loaded into known GPS devices. In the same connection, the coordinates of the store aisles and items can be stored in the system and programmed to communicate with various known GPS devices. In one embodiment, the map-list can be downloaded into a portable electronic device with GPS capacity, and the consumer can be navigated through the store, by visual indications on the map indicating the consumer's real time location (shown on the device's display) and, additionally, by voice instructions. This shopping embodiment would be used in a fashion similar to the use of modern GPS devices in automobiles. One of skill in the art would recognize other variations of incorporating GPS functionality into the shopping list map in accordance with the present invention.

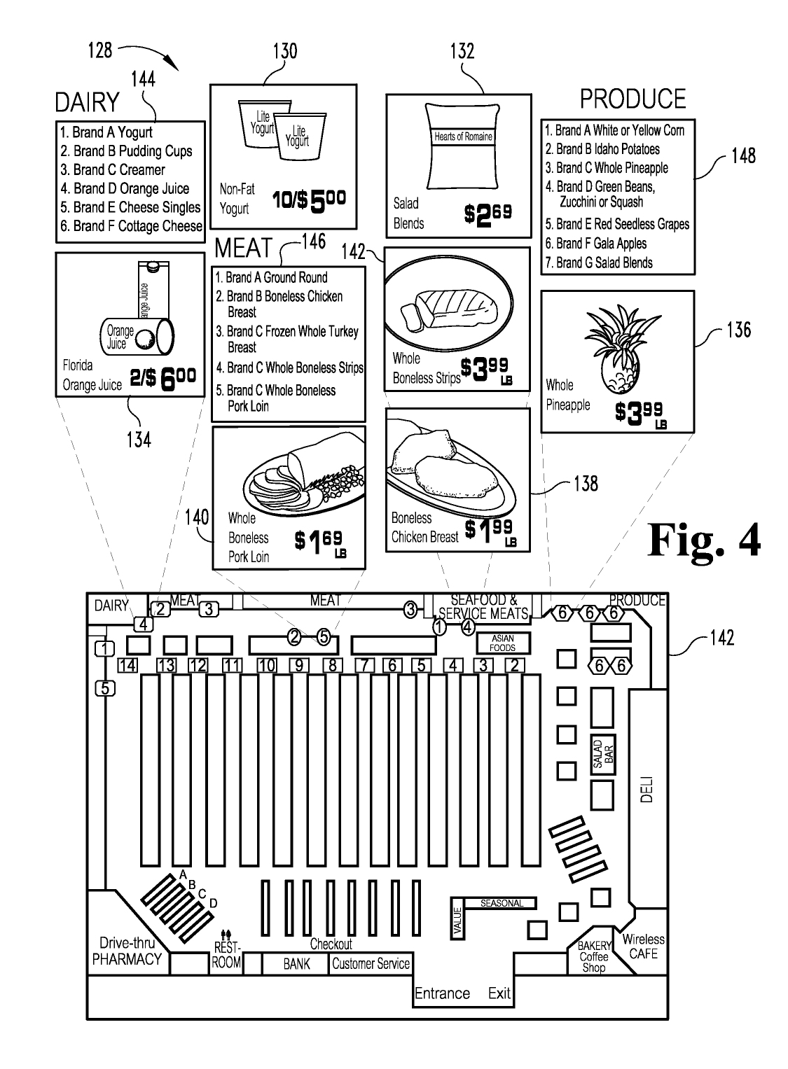

In still other embodiments, and as described in more detail below with reference to a flyer embodiment, it is possible to integrate map shopping list 80 with coupons. That is, in addition to the coupon feature 60 described above, other coupons may be available for items on the consumer's list or coupons may be available for competitor's items which the store wishes to market. The map 80 can include these coupons and show the locations of the items on the coupons on the map, similar to the flyer embodiment described next with reference to FIG. 4.

These teachings also provide an innovative flyer system that can reach out to consumers who are not currently customers of a target retail store and who may be averse to shopping there as a result of being unfamiliar with the store, its layout and its offerings. A flyer system in accordance with these teachings can personalize information from a particular retail location in a way that will attract new shoppers and increase sales.

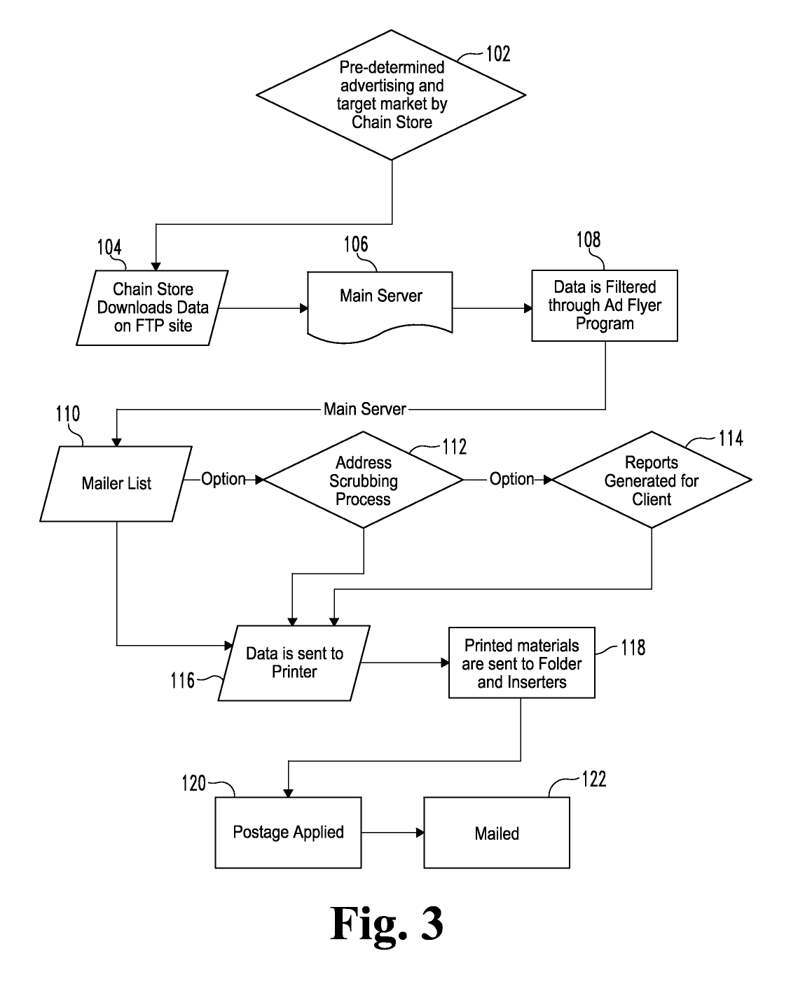

As indicated in FIG. 3, the first step 102 in generating the flyer is to acquire predetermined advertising and target market information from the chain store and transfer this data at steps 104 and 106 to the main server. The data is filtered at step 108 to eliminate unwanted addresses and a mailer's list 110 is generated. Addresses can be scrubbed at 112 and reports 114 can optionally be generated for the client store concerning the mailing. The information is sent to a printer and organized at steps 116 and 118, and postage is applied and the flyers mailed at steps 120 and 122.

The flyer produced by this process can include a store layout, coupons, item locations, commodities list, shopping list section and personalized messaging for the particular consumer. The store layout is a graphically designed image of the retail floor plan of the store, aisle by aisle, including cash registers, customer service office, meat department, bakery, floral department, etc. The coupons provide incentives for the consumer to visit the store and can also be associated with a particular location on the store layout to show where the coupon item is located. The store exact items for the coupons can be determined by the retailer to display selected products in particular stores. Promotional item locations can also be located on the store layout by commodity, sub commodity, brand, and size. A commodities list includes products, not brand precise, with aisle location for quick education of the consumer on product positions in the retail store. The shopping list section on the flyer provides the consumer an area to compile a list of chosen items for purchase. The personalized message can include letters from the manager, store specials, or any other information decided by the retailer that provides further information to the potential customer about the particular store location and/or to encourage them to visit the location.

The target customer list for the flyer can include consumers within a specified pre-determined geographical area and other criteria, for example, income, age, current shopping preferences. The customer list can then be filtered by various address check programs, for example NCOA, COA, Skip Tracing, etc . . . , to verify that the consumer data is accurate.

The store layout can be provided by the retailer and combined with item data laying out location of products for a specific store. A commodities list can be generated with aisle locations. A designed template of each store can be combined with the prior manipulated information that includes a shopping list section. Personalized coupons can be inserted into the flyer along with a message from the retailer. A target market list can be acquired by a third party consumer data compiling company, then filtered and mailed.

FIG. 4 shows one of many possible flyer embodiments. Rather than a typical store mailer flyer which merely includes coupons by themselves, the flyer embodiment 128 integrates the coupons with a store map 142, much like the embodiment described above with regard to FIG. 2. Coupons 130-140 can be copies of coupons that are separately provided in the mailing or can be actual coupons that are cut from the flyer. In addition to the items having coupons, the flyer can also include other items in the same category that the store is desirous of selling. For example, an orange juice coupon 134 is provided and is tied into the “dairy” 144 category, which includes a sub-list of numbered items that the store may wish for the consumer to purchase. The orange juice is numbered item 4 in the list. Using the map, the consumer can quickly locate and place the orange juice into his or her cart and also locate and place in the cart other items on the sublist from category 144.

The innovative list achieves several functions. Like many coupon mailers, it provides saving to the customer and the coupons, themselves, entice the consumer to shop at the particular store. Beyond this, the mailer provides a significant additional enticement for the consumer to shop at the target store because the consumer need not worry about wasting time finding the items. A convenient map is provided. This results in attracting new shoppers that would not visit the target store if only coupons were provided. Also, assuming the consumer indeed uses the coupons and map in the new store, the flyer takes the additional opportunity to introduce the consumer to additional items that he or she may be interested in buying while shopping for the items in the coupons. This not only increases sales, it gives the consumer visiting this new store hands-on experience shopping in the new store, thereby familiarizing him with it and making it more likely that he will return to the store for future shopping.

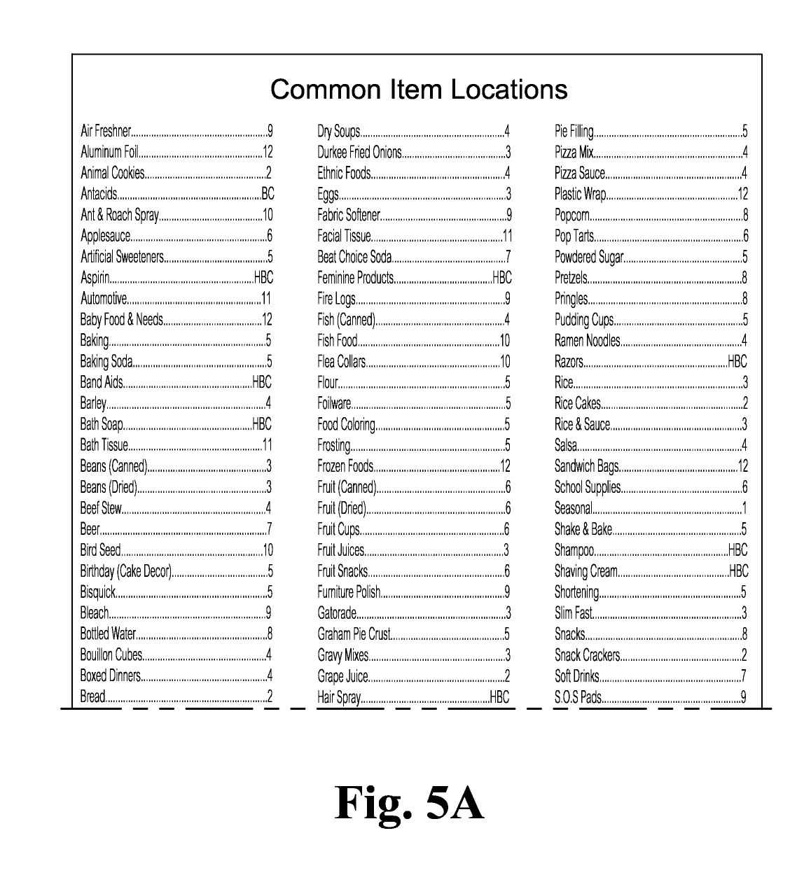

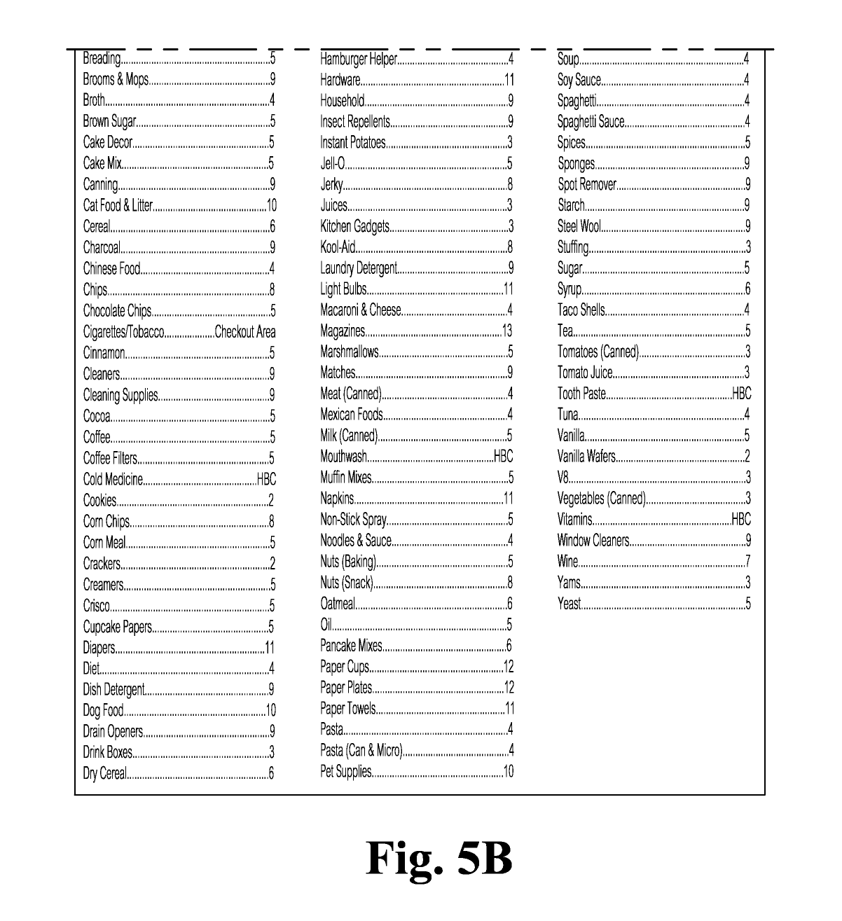

In this connection, the flyer may include a handy list of common items and their aisle locations for the target store, as depicted in FIGS. 5A and 5B. Assuming the flyer successfully results in the consumer entering the store, the common item list can make it easy for the consumer to not only buy the items for which they have coupons, but to complete all of their shopping during the visit.

Similarly, the flyer can include instructions for the consumer to enter the store's website, such that they can make a complete list of shopping items and then proceed to fill the list as described above with reference to FIG. 2. Many other variants of the website and flyer, alone or in combination are possible with the scope of these teachings.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of creating and using a customized shopping map, comprising:
entering a store website;
the store website then communicating with a main server;
building a shopping list of items to be purchased at a physical location of the store;
compiling the list of items and sorting the items by their physical location in the store;
generating a map of the store which includes indicia indicating the locations of the items on the list; and
using the map to handle and purchase one or more of the items on the list.

2. The method of claim 1, wherein the map comprises a document which shows aisles in the store.

3. The method of claim 1, further comprising downloading the map to a portable electronic device, wherein the map comprises an image viewable on or from the portable electronic device.

4. The method of claim 1, wherein the portable electronic device includes GPS, the method further comprising navigating a user to the exact location in the store of at least one the items on the shopping list of items.

5. The method of claim 4, wherein the GPS is integrated with the map, wherein the location in real time of the user can be viewed on the map in real time.

6. The method of claim 1, wherein the indicia comprise Arabic numbers located on the map in positions corresponding to the location of the items in the store.

7. The method of claim 6, wherein the indicia further include colors.

8. The method of claim 7, wherein the colors correspond to a type of item.

9. The method of claim 1, wherein the step of entering the website comprises entering a username and password.

10. The method of claim 1, further comprising sorting the list of items by store aisle.

11. The method of claim 1, further comprising providing instructions on the map for an efficient order in which to place the items on the shopping list into the consumer's cart.

12. The method of claim 1, further comprising sending the map in or as part of an electronic mail message.

13. The method of claim 1, further comprising compiling information about the user based upon the list of items.

14. The method of claim 1, further comprising generating at least one coupon.

15. The method of claim 1, further comprising entering the shopping list to a user history.
